(19) United States
(12) Patent Application Publication
(10) Pub. No.: US 2026/0166746 A1
(43) Pub. Date: Jun. 18, 2026

(54) PROCESS FOR THE AUTOMATED HANDLING OF PRODUCTS WITHIN A PLANT

(71) Applicant: G.D S.P.A., Bologna (IT)

(72) Inventors: Andrea GIUSTI, San Michele all’Adige (Trento) (IT); Marco TODESCATO, Vicenza (IT); Emilio TIRELLI, Bologna (IT); Marco TAGLIAVINI, Bologna (IT); Giovanni MANZIERI, Bologna (IT); Franco Paolo BRIGANTI, Bologna (IT)

(21) Appl. No.: 19/126,071

(22) PCT Filed: Oct. 30, 2023
(86) PCT No.: PCT/IB2023/060898

§ 371 Date: Apr. 30, 2025

(30) Foreign Application Priority Data
Nov. 2, 2022 (IT) 102022000022500
Jun. 30, 2023 (IT) 102023000013704

(51) Int. Cl. B25J 9/16; B65G 47/90

(52) U.S. Cl. CPC B25J 9/1697; B65G 47/905

(57) ABSTRACT

A plant including a workstation which includes a first robotic arm and gripping tools and a process for the automated handling of products within the plant. The process includes arranging the products randomly on a service plane of the workstation, acquiring an image of the products arranged on the service plane and obtaining, by processing the image, geometric characteristics of each of the products arranged on the service plane. For each of the products, the process also includes identifying, based on the respective geometric characteristics which have been obtained, a respective gripping tool among the gripping tools, associating the respective gripping tool with the first robotic arm, and moving the first robotic arm to grasp the product by the respective gripping tool, moving the grasped product from the service plane to an operating station of the plant and releasing the product in the operating station by the respective gripping tool.

### FIELD OF THE INVENTION

The present invention relates to a plant and a process for the automated handling of products within the plant.

### BACKGROUND

In the context of production company logistics, the automated handling of products among the different operating stations of a plant is of particular importance.

For example, especially in medium to large-sized companies with medium to high levels of automation, products can be moved among the abovementioned operating stations by automatic driven vehicles and/or, if products must be temporarily stored in a storage warehouse in anticipation of a future use thereof, automated warehouses can be provided, in which the operations of inserting products inside the storage warehouse and picking up such products from the storage warehouse are controlled by a special warehouse management software.

Often, even in the presence of automated systems, the products are still handled by trained operators in some operating stations.

For example, even in the presence of an automated warehouse, the delivery of products to the storage warehouse is carried out manually by an operator who picks up the products from a pick-up station arranged near the storage warehouse and inserts them in an appropriate collection tray intended to be placed in a predetermined location inside the storage warehouse.

The Applicant has thought to automate some of the operations which are typically carried out manually by the operators, such as for example the delivery of products to an automated warehouse, and has provided for performing the abovementioned operations by robotic arms.

However, the Applicant has noted that the abovementioned products typically have very different shapes and that, in the case of identical products, they may be arranged randomly on the surface from which they must be picked up, thus presenting themselves to the robotic arm which must pick them up with very different spatial arrangements.

In this context, the Applicant has perceived the need to provide a solution which allows the robotic arms to pick up the products safely and stably as well as to maintain an adequate gripping stability during the handling thereof.

### SUMMARY

In a first aspect thereof, the present invention therefore relates to a process for the automated handling of products within a plant.

Preferably, the plant comprises a workstation, which in turn comprises a first robotic arm and a plurality of gripping tools.

Preferably, said products are arranged randomly on a service plane of the workstation.

Preferably, an image of the products arranged on the service plane is acquired.

Preferably, said image is processed to obtain geometric characteristics of each of the products arranged on the service plane.

Preferably, for each of said products, a respective gripping tool is identified among said plurality of gripping tools on the basis of the geometric characteristics respectively obtained.

Preferably, for each of said products, the respective identified gripping tool is associated with the first robotic arm.

Preferably, for each of said products, the first robotic arm is moved to grasp the product by the respective gripping tool and to move the grasped product from said service plane to an operating station of the plant.

The operating station can be adjacent to said service plane.

Preferably, for each of said products, the product is released in said operating station by the respective gripping tool.

In a second aspect, the present invention also relates to a plant.

Preferably, the plant comprises a workstation.

Preferably, the workstation comprises a first robotic arm.

Preferably, the workstation comprises a service plane.

Preferably, the plant comprises an operating station.

The operating station can be adjacent to said service plane.

Preferably, the workstation comprises a plurality of gripping tools arranged near the service plane.

Preferably, the workstation comprises an image acquisition device configured to acquire an image of products arranged on the service plane.

Preferably, the workstation comprises a computer configured to process said image to obtain geometric characteristics of each of the products arranged on the service plane.

Preferably, for each of said products, said computer is configured to identify, on the basis of the geometric characteristics respectively obtained by processing said image, a respective gripping tool among said plurality of gripping tools.

Preferably, for each of said products, said computer is configured to associate the respective gripping tool with the first robotic arm.

Preferably, for each of said products, said computer is configured to move the first robotic arm to grasp the product by the respective gripping tool, move the grasped product from said service plane to said operating station and release the product in said operating station by the respective gripping tool.

Thanks to the provision of a plurality of gripping tools suitable for picking up products with different geometric characteristics and to the fact that each product is handled by a gripping tool which is associated with the robotic arm based on the geometric characteristics which each product has in the acquired image, it is possible to safely and stably handle products with different geometric characteristics by the same robotic arm, thus achieving the desired automation.

The present invention may have at least one of the preferred characteristics described below, taken individually or in combination.

Preferably, the process is implemented by computers.

Preferably, the process is implemented by an appropriate algorithm. The algorithm is preferably updated by special machine learning and/or statistical algorithms.

Preferably, the identification of a respective gripping tool, among said plurality of gripping tools, for each of the products arranged on the service plane comprises:
accessing, on the basis of the geometric characteristics which have been obtained by processing the image, a database comprising instances of product data relating to a predefined plurality of reference products, wherein the product data comprises geometric characteristics of the reference products and each instance of product data is associated with a gripping tool among said plurality of gripping tools, said gripping tool being associated with a respective score indicative of the probability of having a successful gripping;
retrieving from the database instances of product data having geometric characteristics corresponding to the geometric characteristics obtained by processing the image; and
identifying said respective gripping tool among the gripping tools associated with the instances retrieved and on the basis of the scores associated therewith.

Preferably, the geometric characteristics comprise at least one of: shape, size, volume, centre of gravity and spatial arrangement with respect to the service plane.

Preferably, the identification of the respective gripping is performed by taking into account the working area available to the first robotic arm in the workstation.

Preferably, the identification of the respective gripping tool is performed by taking into account the spatial arrangement of the product with respect to the service plane.

Preferably, the identification of the respective gripping tool includes identifying an optimal pair formed by the respective gripping tool and a respective gripping mode.

Preferably, each instance of product data is associated in the database with a gripping tool among said plurality of gripping tools, said gripping tool being associated with a plurality of gripping modes, each pair formed by the gripping tool and one of the plurality of gripping modes being associated with a respective score indicative of the probability of having a successful gripping for the pair.

Preferably, the identification of the optimal pair is performed among the gripping tools and gripping modes associated therewith in the instances retrieved from the database on the basis of the score associated with each pair.

Preferably, the identification of the optimal pair is also performed by taking into account the working area available to the first robotic arm in the workstation.

Preferably, the identification of the optimal pair is also performed by taking into account the spatial arrangement of the product with respect to the service plane.

Preferably, the identification of the optimal pair is performed by selecting, from the pairs associated with the highest score, the one which allows the product to be grasped and handled within the working area by the first robotic arm without encountering obstacles.

Preferably, the gripping mode defines at least one gripping point on the product.

Preferably, the gripping mode defines operating parameters adapted to drive the gripping tool.

Preferably, at least one characteristic parameter of the products arranged on the service plane is obtained.

Preferably, in addition to the geometric characteristics, the product data in the database comprise at least one characteristic parameter of the products of the predefined plurality of reference products.

The characteristic parameter can be selected from weight, material, colour and surface characteristics of the product.

In a preferred embodiment, if for one of the products arranged on the service plane the database is lacking an instance of product data whose geometric characteristics correspond to the geometric characteristics obtained by processing the image, the identification of the respective gripping tool, among said plurality of gripping tools is performed by real-time processing the acquired image.

In a preferred embodiment, if for one of the products arranged on the service plane the database is lacking an instance of product data whose geometric characteristics correspond to the geometric characteristics obtained by processing the image, the identification of the optimal pair is performed by real-time processing the acquired image.

In a preferred embodiment, the service plane is at least in part elastically deformable.

In a preferred embodiment, the service plane is actuatable.

Preferably, the service plane is actuatable by actuators associated therewith which can be driven independently from each other.

Preferably, the actuators can be driven independently from each other in terms of stroke and actuation frequency.

Preferably, before performing said real-time processing of the acquired image, the service plane is actuated so that at least some of the products arranged thereon are moved.

Afterwards, the acquired image is preferably processed again to obtain updated geometric characteristics of each of the products arranged on the service plane.

Afterwards, the database is preferably accessed again on the basis of the updated geometric characteristics to retrieve the instances of product data having geometric characteristics corresponding to the updated geometric characteristics and to identify said respective gripping tool (or said optimal pair) among the gripping tools (and gripping modes) which are associated with the instances thus retrieved from the database on the basis of the scores associated therewith.

Preferably, said real-time processing of the acquired image is performed if the database lacks an instance of product data whose geometric characteristics correspond to the updated geometric characteristics. Preferably, the image acquisition device is arranged above said service plane.

The image acquisition device can comprise a 3D vision system.

The image acquisition device can comprise a camera.

For example, the image acquisition device can use range imagining techniques adapted to provide information on the spatial position of the point for each point in the acquired image.

The image acquisition device can be configured to acquire a point cloud or a pair of 2D images consisting of a 2D brightness image and a 2D depth image.

It should be noted that a brightness image is intended to be a 2D image defined, in an X, Y plane of reference system of an image acquisition device, by a set of brightness (or intensity) values associated with the image points. In turn, a depth image or depth map is a 2D image or map defined, in said X, Y plane, by a set of distance values associated with the points of the image with respect to a predefined point of view.

The image acquisition device can comprises, for example, stereo cameras, TOF cameras (where TOF stands for ‘time-of-flight’) or structured light cameras.

In an embodiment, the products arranged randomly on the service plane are identical to each other. Identical products are intended as a single type of products which could however differ in geometric characteristics due to, for example, packaging (for example, some products could be packaged and others not).

Preferably, before arranging said products randomly on the service plane, said products are contained in a container.

Preferably, arranging said products randomly on the service plane comprises picking up said container by an automated transfer device, such as for example a second robotic arm.

Preferably, arranging said products randomly on the service plane comprises tilting or overturning said container above said service plane by moving said automated transfer device.

Preferably, said container is arranged in a transport tray containing a plurality of containers, each container comprising a plurality of identical products.

Preferably, before picking up said container by said automated transfer device, said transport tray is transferred to a first conveyor adjacent to said service plane.

Preferably, said transfer is performed by a automatic driven vehicle.

Preferably, after having transferred said transport tray to said first conveyor and before picking up said container by said automated transfer device, the transport tray is transferred from said first conveyor to a detection station adjacent to said first conveyor.

Preferably, an image of said transport tray is acquired by an image acquisition device provided in said detection station.

Preferably, by processing the acquired image of the transport tray, a correct positioning of the tray and of the plurality of containers contained therein with respect to predetermined reference parameters is checked.

Preferably, by processing the acquired image of the transport tray, a correct spatial orientation of the transport tray with respect to predetermined reference parameters is checked.

Preferably, before acquiring the image of said transport tray, said transport tray is locked in position in said detection station.

Preferably, the gripping tools are selected from the group comprising: suction cups, callipers, soft callipers, pouring hoppers (funnels), hooks and any combination thereof. Preferably, before releasing each of said products in said operating station, a collection tray is arranged in said operating station.

Preferably, releasing each of said products in said work station comprises depositing said products in said collection tray.

Preferably, after having deposited said products in the collection tray, said collection tray is picked up from said operating station.

Preferably, the collection tray is stored in a predefined location within a storage warehouse.

Preferably, the plant or the workstation comprises one or more sensors configured to detect a characteristic parameter of the products arranged on the service plane selected from: weight, surface characteristics, material and colour.

### BRIEF DESCRIPTION OF THE DRAWINGS

Further features and advantages of the present invention will become clearer from the following detailed description of a preferred embodiment thereof, made with reference to the appended drawings and provided by way of indicative and non-limiting example, in which:

FIG. 1 shows the simplified and schematic layout of a plant in which a process for the automated handling of products in accordance with the present invention is performed;

FIG. 2 shows a plan view from above of a transport tray used in the process of the present invention;

FIG. 3 shows a side view of the transport tray of FIG. 2;

FIG. 4 shows a plan view from above of an accompanying document used in the process of the present invention;

FIG. 5 shows a plan view from above of a collection tray used in the process of the present invention;

FIG. 6 shows a side view of the collection tray of FIG. 5;

FIG. 7 shows a frame of the transport tray of FIG. 2 analysed by a management software of the process of the present invention;

FIG. 8 shows a perspective view of an inlet area of a storage warehouse used in the process of the present invention;

FIG. 9 shows a plan view from above of the inlet area of the storage warehouse of FIG. 8;

FIG. 10 shows a perspective view of a part of the inlet area of the storage warehouse of FIG. 8;

FIG. 11 schematically shows an example of products arranged randomly on a service plane with associated respective gripping points in the case of a suction cup gripping tool;

FIG. 12 schematically shows an example of a database which can be used to implement the process of the invention;

FIG. 13 schematically shows an example block diagram of a possible implementation of the process of the invention.

### DETAILED DESCRIPTION

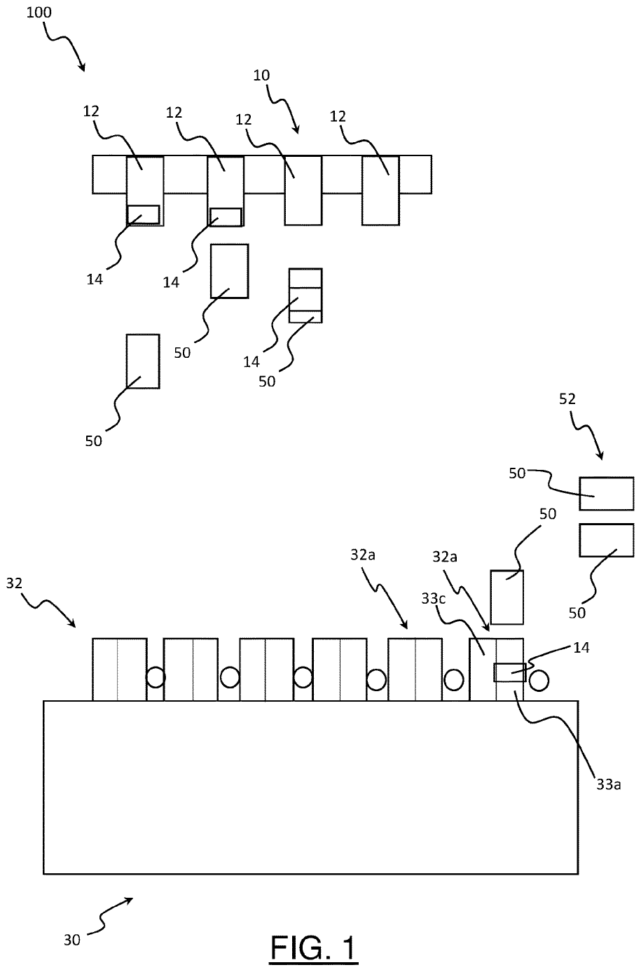

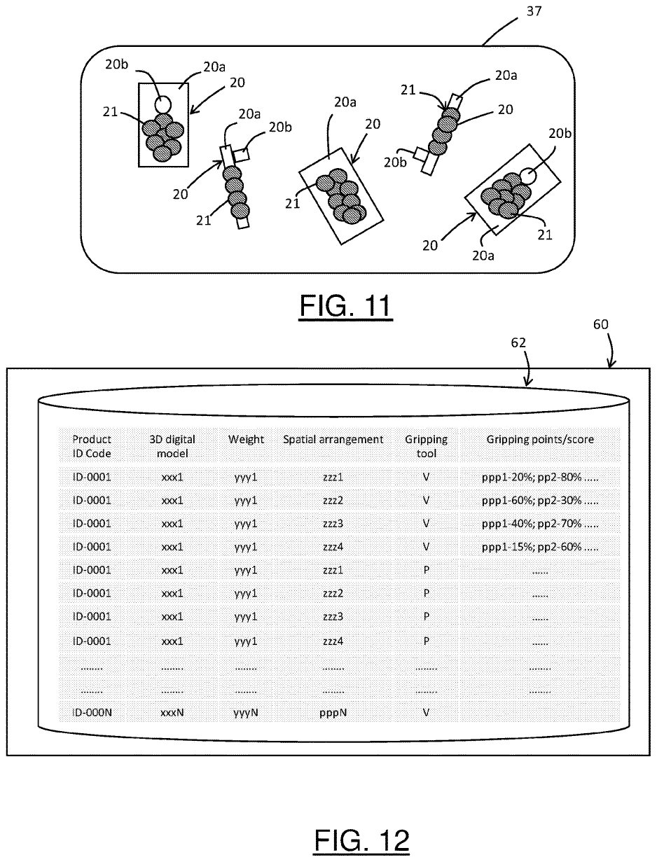

In FIG. 1, numerical reference 100 indicate an area of a plant in which a process for the automated handling of products 20 (shown in FIG. 11) in accordance with the present invention is performed.

The products 20 may come from external suppliers or from other areas of the same plant or from other plants of the same company or corporate group. In a non-limiting example, the products 20 are components or parts of packaging machines, e.g. cigarette packaging machines.

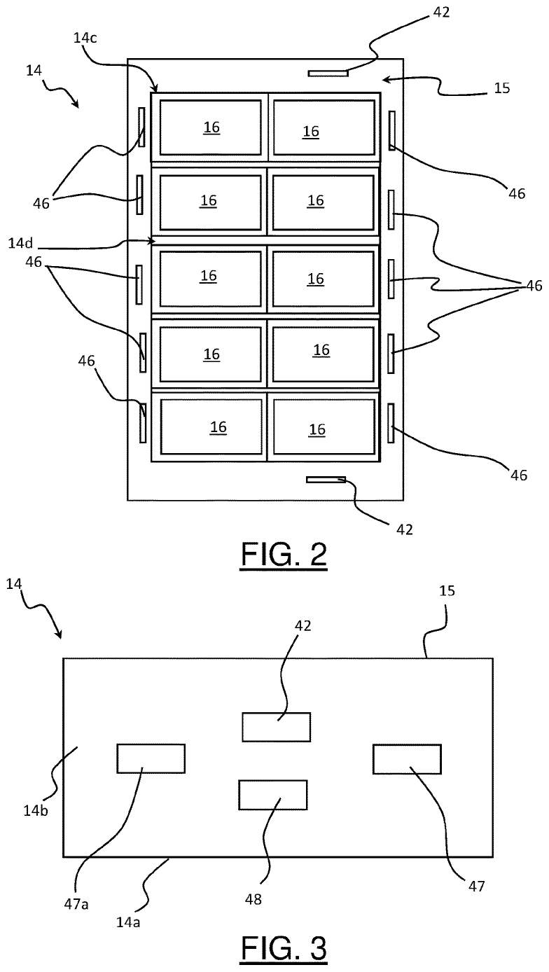

The aforementioned products 20 are initially processed in a product receiving station 10. In this station, the products 20 are placed in containers 16 (FIG. 2), which in turn are arranged in transport trays 14.

In the area 100 of the plant, in addition to the product receiving station 10, a storage warehouse 30 is provided, in which the aforementioned products 20 will be stored in order to be picked up as needed.

Preferably the storage warehouse 30 is an automatic warehouse.

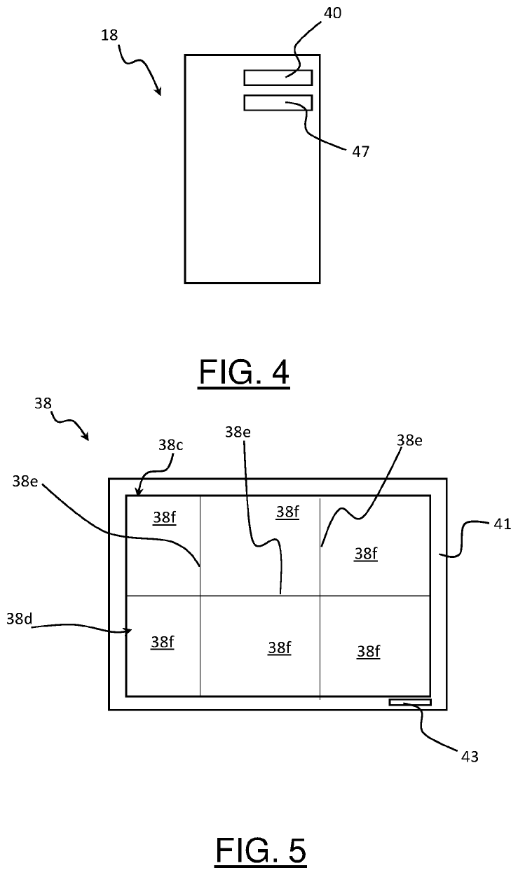

Each product, or each plurality of identical products 20, present in the product receiving station 10 is accompanied by an accompanying document 18, shown in FIG. 4. This document 18 shows the number and type of products 20 that are correlated thereto. This information is also contained in a product identification code 40 printed on document 18 itself. Preferably, this product identification code 40 is an optical code which can be read by an optical reader, more preferably a bar code.

The accompanying document 18 may be prepared by the operator attending the product receiving station 10 or directly by the supplier of the products 20 and be delivered to the product receiving station 10 together with the products 20 themselves.

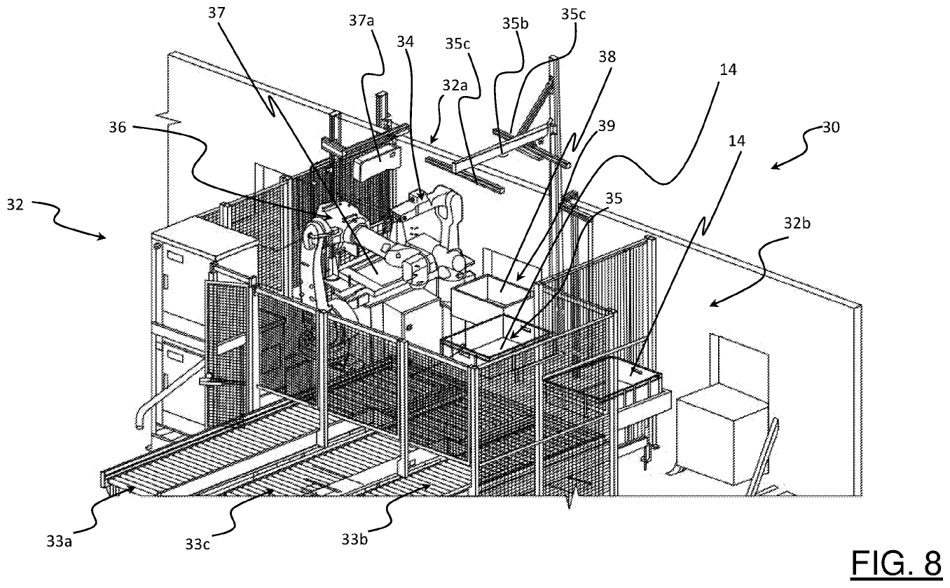

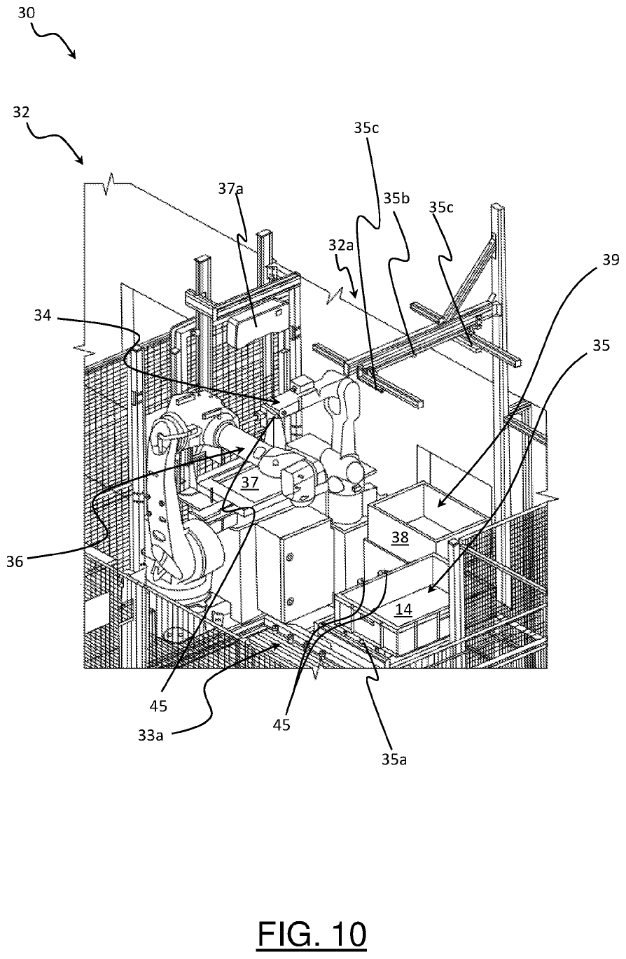

In some embodiments, such as the one illustrated herein, a first service optical code 47 is also printed on the accompanying document 18, which identifies the possibility of handling the respective products 20 by a robotic arm 36 provided in a robotic inlet station 32a of the storage warehouse 30 (FIG. 8-10). However, embodiments are foreseen in which the accompanying document 18 does not have the aforementioned first service optical code 47.

The product receiving station 10 comprises a plurality of product loading stations 12, where various operators place the products 20 to be stored in their respective containers 16 and place the latter in the transport trays 14.

Transport trays 14 without containers 16 are transferred to the product loading stations 12 to be loaded with containers 16 at least partially filled with products 20.

The transfer of each transport tray 14 to a product loading station 12 can take place after the operator has called an automatic driven vehicle 50 which, starting from a parking area 52 in which a plurality of automatic driven vehicles 50 are present, reaches the product loading station 12. This call is made by the operator e.g. by actuating a call button (not shown) specifically provided at the product loading station 12.

With reference to FIGS. 2 and 3, each transport tray 14 has a substantially parallelepiped shape and comprises a bottom wall 14a, four side walls 14b and, on a side opposite to the bottom wall 14a, an upper perimeter edge 15 delimiting a top opening 14c. The top opening 14c allows access to an essentially parallelepiped-shaped compartment 14d.

In the context of this description and the accompanying claims, spatial references such as “upper”, “top”, “above” or the like, and “bottom”, “below” or the like, are to be understood as referring to an operating position of the transport tray 14 as the one shown in FIGS. 8-10 herewith attached, wherein the transport tray 14 it rests by its bottom wall 14a.

The compartment 14d accommodates the containers 16, which are ten in the non-limiting example of FIG. 2.

The containers 16 have a substantially parallelepiped shape.

The containers 16 are arranged in the transport tray 14 side by side. In the non-limiting example of FIG. 2, the containers 16 are arranged in two rows of five containers 16 side by side along the respective long sides of the transport tray 14.

Preferably, the containers 16 are storage boxes with open front.

The operator places the products 20 in the transport tray 14, separating them according to product type. Each container 16 therefore contains products 20 of the same type. The containers 16 of the same transport tray 14 may contain identical or even different products 20. Some containers 16 can contain a single product, if it is large.

The products 20 can be placed in their respective containers 16 before placing the containers 16 in the transport tray 14 or after placing the containers 16 in the transport tray 14.

The products 20 are identified at the product receiving station 10 by reading the product identification code 40 printed on the accompanying document 18.

After having loaded the products 20 into the container 16, the accompanying document 18 is also placed in the container 16 together with the products 20 that are correlated thereto.

The product identification code 40 can be read before placing or after having placed the products 20 in the containers 16 and before placing or after having placed the containers 16 in the transport tray 14.

Each transport tray 14 has a respective tray identification code 42.

The tray identification code 42 is preferably arranged either on the upper perimeter edge 15 of the transport tray 14, so as to be visible when viewing the transport tray 14 from above, or on a side wall 14b of the transport tray 14.

Preferably, the tray identification code 42 is an optical code, more preferably a bar code, which can be read by an optical reader.

An alphanumeric code (not shown) that allows a visual identification of the transport tray 14 by operators is associated next to the tray identification code 42.

In the embodiment shown in FIG. 2, two tray identification codes 42 are provided on the upper perimeter edge 15 of the transport tray 14. They are arranged opposite the top opening 14c in a position adjacent to one of the long sides of the transport tray 14. This positioning identifies the row in which the first five containers 16 are to be placed, starting from the left (or from the bottom with reference to the position of the transport tray 14 in FIG. 2) towards the right (or upwards with reference to the position of the transport tray 14 in FIG. 2). The second row of containers 16 is to be positioned adopting a positioning sequence identical to that of the first row of containers 16. For example, with reference to FIG. 7, the ten containers 16 are arranged in succession in the positions numbered I-Docket X, with position I located adjacent to the left-hand tray identification code 42 (or below with reference to the position of the transport tray 14 in FIG. 7), positions II-V arranged side-by-side along the row between the two tray identification codes 42, positions VI-X arranged along a row adjacent to that of positions I-V and close to positions I-V respectively.

Before or after filling the transport tray 14 with containers 16 that are in turn at least partially filled with products 20, the transport tray 14 is identified by the operator by reading one of the tray identification codes 42.

As shown in FIGS. 2 and 3, the transport tray 14 further comprises, on its upper perimeter edge 15, a plurality of container positioning identification codes 46. Each of these codes 46 is arranged adjacent to a respective zone of the compartment 14d configured to receive a respective container 16.

Preferably, the container positioning identification codes 46 are optical codes, more preferably bar codes, which can be read by an optical reader.

After each container 16 has been placed in transport tray 14, the position of that container 16 (and thus of the products 20 and quantities of products 20 contained therein) with respect to the transport tray 14 is identified by reading the container positioning identification code 46 adjacent to that container 16.

Again with reference to FIG. 3, the transport tray 14 further comprises a first service optical code 47 which identifies the possibility of being emptied by the robotic arm 36 provided in a robotic inlet station 32a of the storage warehouse 30 (FIGS. 8-10). This code 47 is identical to the first service optical code 47 that may be printed on the accompanying document 18.

In the embodiment illustrated here, the transport tray 14 also comprises a second service optical code 47a, which identifies that it can also be emptied manually by an operator.

The first service optical code 47 and the second service optical code 47a are arranged on the side wall 14b of the transport tray 14 where the tray identification code 42 is also arranged.

Thus, the transport tray 14 shown in the appended figures is suitable for being emptied either by the robotic arm 36 or manually. The operator, by reading either the first service optical code 47 or the second service optical code 47a by an optical reader, determines the type of robotic or manual emptying of the transport tray 14. All the containers 16 contained in a transport tray 14 of which the first service optical code 47 is read will be emptied by a robotic arm, just as all the containers 16 contained in a transport tray 14 of which the second service optical code 47a is read will be emptied manually.

Transport trays 14 containing only the first service optical code 47 can be provided. These trays 14 should only be filled with products 20 accompanied by an accompanying document 18 which also bears the first service optical code 47.

Additional transport trays 14 containing only the second service optical code 47a may also be provided. These trays 14 should only be filled with products 20 accompanied by an accompanying document 18 that does not have the first service optical code 47.

Any reading inconsistencies such as, for example, the reading of a first service optical code 47 on an accompanying document 18 placed in a container 16 and not also on the transport tray 14 in which the container 16 containing that accompanying document 18 and the corresponding products 20 are placed, or vice versa, or the reading of a first service optical code 47 on an accompanying document 18 placed in a container 16 and a second service optical code 47a on the transport tray 14 in which the container 16 containing that accompanying document 18 and the relevant products 20 are placed, generates an alarm signal alerting the operator to make the appropriate checks.

Again with reference to FIG. 3, the transport tray 14 also comprises, on the same side wall 14b where the tray identification code 42 is also arranged, an optical tray completion code 48. The operator reads this optical code 48 to signal to a computer system 60 (schematically shown in FIG. 12) that manages the storage warehouse 30 that the loading operations of the products 20 into their respective containers 16 and of the latter into the transport tray 14 are complete and therefore that the transport tray 14 can be transferred to the storage warehouse 30.

The computer system 60 managing the storage warehouse 30 can comprise one or more local computers provided with appropriate software and/or firmware configured to implement the process of the invention.

The one or more local computers can be networked together and can possibly be connected to a remote server.

The transfer of the transport tray 14 to the storage warehouse 30 can occur by an automatic driven vehicle 50.

The transfer of the transport tray 14 from the product receiving station 10 to the automatic driven vehicle 50 and from there to the storage warehouse 30 takes place by moving respective conveyors, e.g. roller conveyors.

When the computer system 60 that manages the storage warehouse 30 detects that the storage warehouse 30 is in a condition to receive the products 20 contained in the transport tray 14, a request to withdraw the transport tray 14 is sent.

Following this request, an automatic driven vehicle 50 moves from the parking area 52 to the product receiving station 10 and, after loading the transport tray 14, from the product receiving station 10 to an inlet area 32 of the storage warehouse 30.

The aforementioned other automatic driven vehicle 50 may or may not be the same one that previously brought that same transport tray 14 empty to the product receiving station 10.

In the inlet area 32 of the storage warehouse 30, the products 20 placed in the containers 16 contained in the transport tray 14 are transferred to collection trays 38, separated according to their type (FIGS. 8-10). The collection trays 38, although not necessarily completely filled, are then placed in a predefined location within the storage warehouse 30.

The inlet area 32 may comprise a plurality of robotic inlet stations 32a, as shown in FIG. 1, or both a robotic inlet station 32a and a non-robotic inlet station 32b, as shown in FIGS. 8-10. In the latter case, the automatic driven vehicles 50 transfer the transport trays 14 to the robotic inlet station 32a or to the non-robotic inlet station 32b depending on whether the first service optical code 47 or the second service optical code 47a has been read.

Each robotic inlet station 32a of the storage warehouse 30 comprises robotic arms 34 and 36, and a feed conveyor 33a. The robotic arms 34 and 36 are placed next to the feed conveyor 33a.

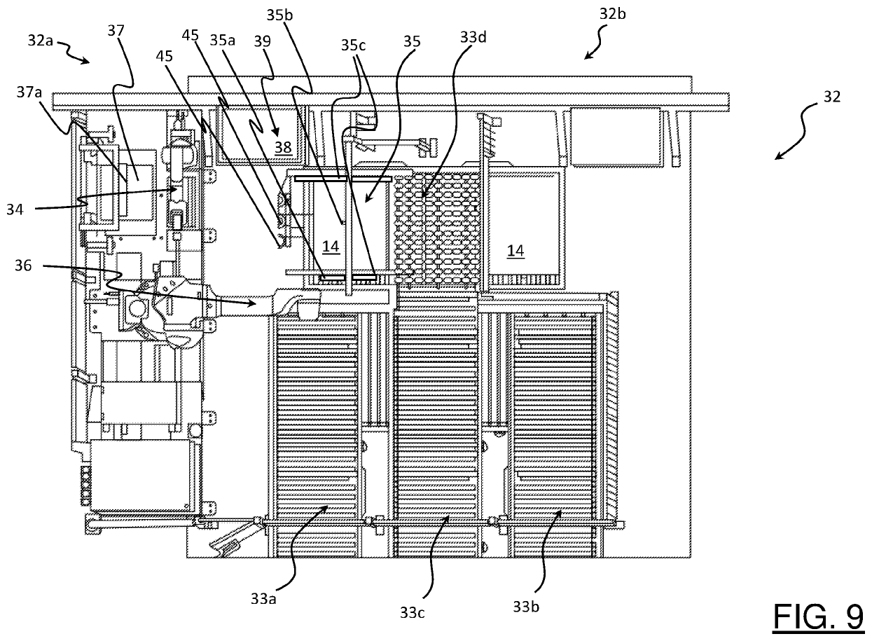

The transport tray 14 is transferred from the automatic driven vehicle 50 to the feed conveyor 33a and by the latter to a detection station 35 where the transport tray 14 is locked in a fixed position by removable locking elements 35a (FIG. 9).

A vision system comprising a camera 35b and a pair of infra-red illuminators 35c is provided in the detection station 35. The vision system is arranged so that it illuminates the transport tray 14 from above and captures an image of it, such as the one shown in FIG. 7.

This is made in order to detect the tray identification code 42 and to check that the containers 16 and the transport tray 14 are in the correct position.

In the non-limiting example in FIG. 7, the areas which in the image captured by the camera 35b identify the correct positioning of the transport tray 14 (the dashed line defining the dashed rectangle 35d) and the containers 16 (the dashed lines at a short side 35e of each container 16) are indicated by dashed lines. For example, it can be foreseen that in the case of correct positioning the aforementioned dashed lines will be green, while in the case of incorrect positioning the aforementioned dashed lines will turn red. In the latter case, the computer system 60 that manages the storage warehouse 30 warns an operator about the need to manually correct the position of the transport tray 14 and/or the containers 16 until the dashed lines turn green.

The vision system further allows to check the correct spatial orientation of the transport tray 14. This is done by identifying the position of the tray identification codes 42 arranged on the upper perimeter edge 15 of the transport tray 14.

The abovementioned checks allow to advantageously control that in the product receiving station 10 the containers 16 have been correctly arranged within the transport tray 14 as described with reference to FIG. 2. Furthermore, they advantageously allow to ensure the proper operation of the robotic arm 36 which picks up the containers 16 from the transport tray 14.

Next to the feed conveyor 33a, a service plane 37 and a table supporting a plurality of different types of gripping tools 45 (FIG. 9) are provided. The gripping tools 45 can be suction cups, callipers, soft callipers, pouring hoppers (funnels).

Preferably, the service plane 37 has a continuous elastically deformable surface. For example, this can be obtained by making the service plane 37 wholly or partly of an elastically deformable material (such as rubber) and/or by providing the service plane 37 with elastically deformable supports (for example by providing it with sprung and/or rubber feet which support it).

This characteristic of the service plane 37 advantageously allows to avoid damage to the service plane 37 itself or to the gripping tool 45 associated with the robotic arm 34 during the gripping of the product 20 by the gripping tool 45.

Furthermore, the service plane 37 is preferably actuatable (for example movable and/or deformable) by special actuators (not shown).

The actuators can preferably be driven independently from each other. For example, the actuators can be driven independently from each other in terms of stroke and actuation frequency.

This advantageously allows the service plane 37 to temporarily assume different shapes and configurations as required.

In particular, as described in more detail below, the service plane 37 may be subject to different movements (tilting, oscillations, vibrations, local deformations and/or jolting movements) to move the products 20 arranged thereon, as required.

The computer system 60 that manages the storage warehouse 30 can be configured so as to establish where and how to manage identical products 20 contained in each container 16 placed in the transport tray 14.

For example, depending on predefined criteria, the computer system 60 can establish to transfer the products 20 contained in the container 16 according to a first mode which provides for pouring them all together directly in one of the collection trays 38 or according to a second mode which provides for transferring them one by one in said collection tray 38 after having poured them all together on the service plane 37.

When the computer system 60 selects the first transfer mode, the robotic arm 36 picks up the container 16 of interest contained in the transport tray 14 and moves it over the collection tray 38, tilting or overturning it, so as to pour in the collection tray 38 the identical products 20 contained in the container 16, for example with the aid of a special funnel supported by the robotic arm 34.

The criteria for choosing one or the other of the possible transfer modes of the products 20 can be based on various parameters, such as the delicateness/robustness of the products 20, their size and their quantity in the container 16. For example, the computer system 60 can be configured to select the first mode in the event of products 20 which are robust, small and in large numbers (but in any case in quantities less than the capacity of the collection tray 38). In turn, the computer system 60 can be configured to select the second mode in the event of products 20 in quantities exceeding the capacity of the collection tray 38 or in the event of products 20 which are delicate or of a particular shape or of relatively large size which could get stuck together or in the funnel or be damaged during the pouring into the collection tray 38 using the first bulk transfer mode.

When the computer system 60 selects the second transfer mode, the robotic arm 36 picks up the container 16 of interest contained in the transport tray 14 and moves it over the service plane 37, tilting or overturning it, so as to pour onto the service plane 37 the identical products 20 contained in the container 16. The robotic arm 36 then places the container 16 emptied of products 20 back into the transport tray 14 at the previous position thereof.

The products 20 are thus arranged randomly on the service plane 37.

A 3D vision system 37 a is arranged above the service plane 37, which acquires an image of the products 20 arranged on the service plane 37.

The computer system 60 that manages the storage warehouse 30 obtains from such an image geometric characteristics of each of the products 20 arranged on the service plane 37.

As explained in more detail below with reference to FIGS. 11-13, depending on the geometric characteristics obtained for each of the products 20, the abovementioned computer system 60 selects the most suitable gripping tool 45 for picking up each of the products 20.

The robotic arm 34 couples to the selected gripping tool 45 and grasps each of the products 20 arranged on the service plane 37.

The robotic arm 34 is then moved to move each of the grasped products 20, one at a time, from the service plane 37 to an operating station 39 adjacent to the service plane 37 and where the collection tray 38 is placed. The robotic arm 34 then releases each of the products 20 one at a time in the collection tray 38 according to the second transfer mode. The collection tray 38 arranged in the operating station 39 can be empty or can contain some products 20 of the same type as those being picked up from the service plane 37.

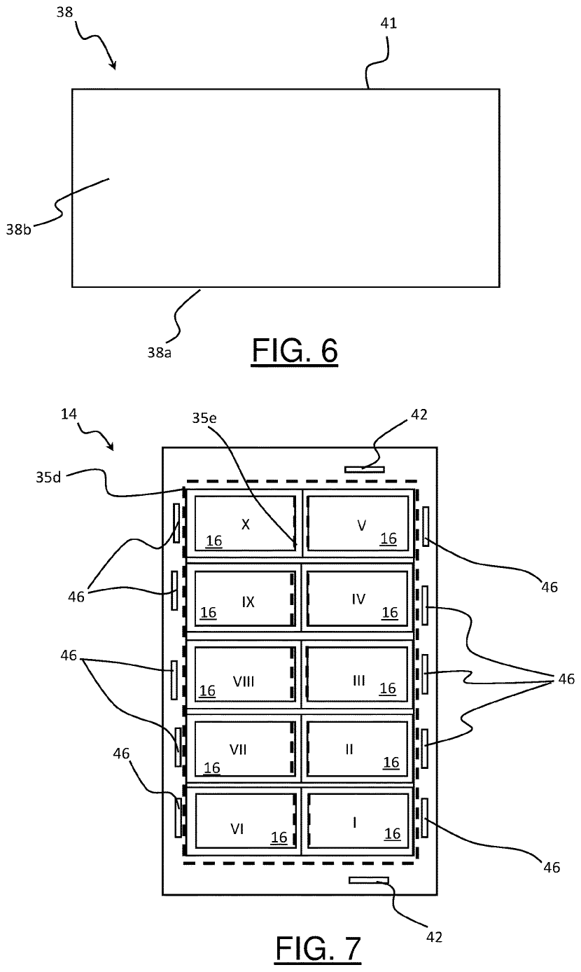

With reference to FIGS. 5 and 6, the collection tray 38 has a substantially parallelepiped shape and comprises a bottom wall 38a, four side walls 38b and, on the side opposite to the bottom wall 38a, an upper perimeter edge 41 delimiting a top opening 38c. The top opening 38c allows to have access to a substantially parallelepiped-shaped compartment 38d. In such a compartment 38d, a plurality of separators 38e may be positioned, e.g. orthogonally to each other, to define a plurality of compartments 38f, e.g. parallelepiped-shaped, which in the non-limiting example of FIG. 5 are six in number.

A tray identification code 43, which is preferably an optical code that can be read by an optical reader, is arranged on the upper perimeter edge 41.

After the robotic arm 34 has placed the products 20 in the collection tray 38, the latter is picked up from the operating station 39 and placed in the predefined location within the storage warehouse 30.

The transport tray 14 from which the products 20 inserted in the collection tray 38 have been picked up is transferred from the detection station 35 of the storage warehouse 30 to a sorting station 33d adjacent to the detection station 35, then from the sorting station 33d to an unloading conveyor 33c adjacent to the feed conveyor 33a and finally moved away from the unloading conveyor 33c by a automatic driven vehicle 50.

In the specific example of FIGS. 8-10, a non-robotic inlet station 32b is provided alongside the robotic inlet station 32a. The non-robotic inlet station 32b comprises a feed conveyor 33b and shares the sorting station 33d and unloading conveyor 33c with the robotic inlet station 32a.

In the non-limiting example of FIGS. 8-10, the feed conveyors 33a and 33b and the unloading conveyor 33c are essentially parallel to each other. The unloading conveyor 33c is interposed between the feed conveyors 33a and 33b.

With reference to FIGS. 11-13, an embodiment of how the computer system 60 can select the optimal gripping tool 45 and, in particular, the optimal gripping tool-gripping point pair for grasping each product 20 arranged on the service plane 37 is now described.

FIG. 11 shows the products 20 randomly overturned onto the service plane 37 by the robotic arm 36 in an example case of identical products 20 consisting of a parallelepiped-shaped plate 20a with a pin 20b on one of the two larger faces of the plate 20a.

As can be seen in the example of FIG. 11, the products 20 have different spatial arrangements with respect to the service plane 37. In particular, the products 20 are positioned in different positions on the service plane 37, for example in a central, side, bottom, top, right, left etc. etc. position, which can be defined by predetermined coordinates of an appropriate reference system. Furthermore, the products 20 are arranged on the service plane 37 with different support positions (viz., they rest on the service plane 37 with different surfaces, edges or support points). Furthermore, even if not shown, the products 20 could be completely or partially overlapping each other and thus be, for example, tilted with respect to the service plane 37. For example, with reference to the position of the service plane 37 in FIG. 11, the product 20 placed at the top left is supported on service plane 37 with the largest surface (that is, the one without a pin) which is free; the central product 20 is supported on the service plane 37 with the largest surface provided with a pin; the product 20 placed at the bottom right is supported on the service plane 37 with the largest surface (that is, the one without a pin) which is free; the other two products 20 are supported on the service plane 37 with one of the two smaller surfaces.

According to the invention, given a predefined plurality of N reference products (with integer N greater than 1), the computer system 60 is configured to analyse a priori (off-line) geometric characteristics of the N reference products to determine, for each reference product and for the most probable stable spatial arrangements which the reference product can assume with respect to the service plane 37 after a random overturning thereon, respective gripping points 21 for each gripping tool 45 of said plurality of gripping tools 45. The predefined plurality of N reference products can, for example, be defined by a list of catalogue products which can be stored in the storage warehouse 30.

The geometric characteristics of the reference products can, for example, be supplied to the computer system 60 in the form of three-dimensional digital models which three-dimensionally represent shape, dimensions, volume and centre of gravity of the reference products.

The gripping points 21 define the positions (defined by predetermined coordinates of an appropriate reference system) of points or areas on the surface of the reference product at which the reference product is adapted to be grasped by the gripping tool 45 under consideration.

Preferably, when determining the gripping points, the computer system 60 is configured to also take into account other characteristic parameters of the reference products such as weight, material, colour and possibly surface characteristics (such as roughness, porosity, slipperiness, deformability etc. etc.).

FIG. 11 shows indicatively and by way of example gripping points 21 which could be determined for a gripping tool 45 consisting of a suction cup for the different spatial arrangements shown in FIG. 11 in the case of a reference product similar to the product 20 shown in FIG. 11, that is consisting of a parallelepiped-shaped plate 20a with a pin 20b on one of the two larger faces of the plate 20a.

In the example of FIG. 11, the gripping points 21 are indicatively illustrated as small cylinders simulating the area grasped by a suction cup having the diameter of the cylinder. In the event of other gripping tools 45, the gripping points 21 may be represented by different areas or patterns at the surface of the products 20.

According to the invention, the computer system 60 is configured to also determine a priori (off-line) an indicative score of a probability of success for each gripping point 21 determined for each gripping tool 45 in association with each possible stable spatial arrangement for each reference product.

Preferably, in addition to the score, the computer system 60 is configured to also determine a priori (off-line) operating parameters useful for appropriately driving the gripping tool 45 under consideration. For example, such operating parameters can be related to currents, control voltages, suction pressure for a suction cup, compression pressure, clamping force and degree of opening for a calliper and the like.

The results of the abovementioned analyses are stored in a database 62 of the computer system 60 indicatively shown in FIG. 12.

The database 62 is therefore compiled a priori (off-line) and the data therein is generally calculated overnight each time a new product is created by a technical department and meets certain size and weight constraints.

By way of example, the database 62 comprises a plurality of records, indicatively illustrated as rows of a table in the schematic representation in FIG. 12.

Each record comprises data related to:
an identification code of the reference product (corresponding to the product identification code 40 mentioned above),
geometric characteristics of the reference product (for example stored in the form of three-dimensional digital models of the product),
weight of the reference product,
possible stable spatial arrangement with respect to the service plane 37,
gripping tool,
list of the determined gripping points with respective scores.

In particular, in the example of FIG. 12, for the reference product identified with the identification code ID-0001, having predetermined geometric characteristics and a predetermined weight (indicatively indicated with xxx1 and yyyy1, respectively), four possible stable spatial arrangements with respect to the service plane 37 (indicatively indicated with zzz1, zzz2, zzz3, zzz4) are analysed for two gripping tools (suction cup, indicatively indicated with the letter “V” and calliper, indicatively indicated with the letter “P”). The last column comprises the gripping points determined for each record with the related score. Even if not illustrated, for each gripping point, the last column could also comprise operating parameters useful for driving the gripping tool under consideration.

According to the invention, after the products 20 contained in a container 16 are arranged randomly on the service plane 37, the computer system 60 is adapted to identify the optimal gripping tool-gripping point pair for grasping each product 20.

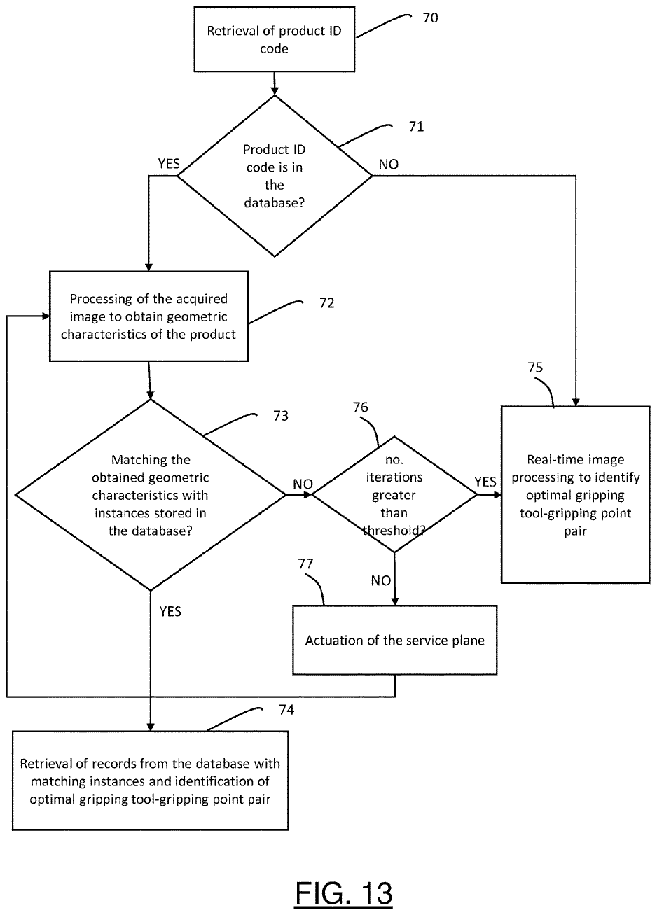

FIG. 13 illustrates a block diagram showing indicatively a process for the automated handling of products implemented by the computer system 60 for each product 20 arranged on the service plane 37.

At block 70, the product identification code 40 of the product 20 is obtained.

At block 71, it is checked whether the product identification code 40 which has been obtained is present in the database 62.

If the product identification code 40 which has been obtained is present in the database 62, at block 72 geometric characteristics of the product 20 (comprising, for example, at least one of: shape, size, volume, centre of gravity, spatial arrangement with respect to the service plane 37) are obtained from the image acquired by the 3D vision sensor 37 a, and, possibly, other characteristic parameters of the product 20, such as the weight (acquired by a suitable sensor, not shown, which could be arranged in the plant in a station upstream of or at the robotic inlet station 32a) are obtained.

At block 73, a check is made that the geometric characteristics of the product 20 (for example, shape, size and spatial arrangement with respect to the service plane 37) and, where appropriate, other characteristic parameters of the product 20 correspond (according to predefined correspondence criteria) with instances of product data stored in the various records of the database 62 for the product identification code 40.

In the event of a match, at block 74 the records corresponding to instances of product data having geometric characteristics and, possibly, other characteristic parameters corresponding to those obtained at block 72 from the product 20 arranged on the service plane 37 are retrieved from the database 62.

At block 74, a most suitable gripping tool 45-gripping point 21 pair is identified, among the retrieved records, on the basis of the information contained in the database 62 and on the basis of the spatial arrangement of the product 20 with respect to the service plane 37.

In particular, at block 74, a ranking of gripping tool 45-gripping point 21 pairs are preferably defined on the basis of the score associated therewith in the records retrieved from the database 62 and, from the ranked pairs with the highest score, the one which allows the robotic arm 34 to safely grasp the product 20 taking into account the spatial arrangement of the product 20 with respect to the service plane 37 and the obstacles present in the working area within the robotic inlet station 32a is chosen.

Once the optimal gripping tool-gripping point pair has been selected, the operating parameters useful for driving the gripping tool of the selected pair can also be derived (when present) from the last column of the database 62.

For example, for the database 62 shown in FIG. 12, if the product identification code 40 of the product 20 corresponds to ID-0001 and the spatial arrangement of the product 20 corresponds to zzz2, once a match has been ascertained at block 73, at block 74 the instances of product data present in the second and sixth records (second and sixth rows) of the database 62 are retrieved and the ranking of the gripping tool-gripping point pairs is defined on the basis of the data present in the last column of such records.

Returning to block 71, if it is verified that the product identification code 40 obtained is not present in the database 62, at block 75 the most suitable gripping tool 45-gripping point 21 pair for handling the product 20 is identified by a real-time processing of a point cloud provided by the 3D vision system 37a.

The real-time processing can be carried out by algorithms implemented, for instance, by artificial intelligence, neural network or expert system.

Preferably, such algorithms are assisted by appropriate machine learning and/or statistical algorithms.

Returning to block 73, in the absence of matching between the geometric characteristics of the product 20 and, possibly, the other characteristic parameters of the product 20 with instances of product data stored in the various records of the database 62 for the product identification code 40, it is provided to pass to block 76 in which it is checked whether a certain threshold number of iterations of the check has been exceeded.

If the threshold number is exceeded, it is provided to move to block 75.

If the threshold number is not exceeded, in block 77 the service plane 37 is actuated by the actuators described above so as to change the spatial arrangement of the products 20 with respect to the service plane 37. As mentioned above, the actuators can be driven so as to tilt, oscillate, vibrate or jolt or temporarily deform the service plane 37. The optimal specific action to be actuated can preferably be chosen depending on the information from the processing of the image acquired by the 3D vision system 37 a. For example, it might be useful to move some products 20 towards the centre or the edges of the service plane 37 and so on.

After the execution of block 77, it is provided to return to the execution of blocks 72 and 73.

The provision of the real-time processing performed at block 75 advantageously allows to manage cases of products 20 arranged on the service plane 37 which are not included in the predefined plurality of N reference products. This can occur, for example, in the event of new products which have not yet been entered into the database 62.

The real-time processing performed at block 75 also allows to manage cases of products 20 which are present in the database 20 but appear on the service plane 37 with geometric characteristics which differ from those associated with the corresponding reference product. This can occur, for example, in the event of products 20 which turn out to have a very different external appearance from that provided by the three-dimensional digital model stored in the database 62. Consider, for example, the case of packaged products (for example a screw packed in a parallelepiped-shaped casing) or the case of products 20 which, being stacked or piled up on the service plane 37 due to the random overturning, are difficult to distinguish from each other.

In the event of products 20 which, being overlapped or piled up on the service plane 37 due to the random overturning, are difficult to distinguish from each other, the execution of blocks 76 and 77 advantageously allows to try to move the service plane 37 a certain number of times in order to better separating the products 20 from each other and making them more easily identifiable and distinguishable from each other.

Although not shown in FIG. 13, it can also be provided—in the event of failure to identify the gripping tool 45-gripping point 21 pair at block 75-to return to the execution of block 77 for a further attempt before calling an operator to manage the failure.

In addition or as an alternative, although not shown in FIG. 13, it can also be provided in the event of failure at block 74-to pass to the execution of block 77 for a further attempt before calling an operator to manage the failure.

Therefore, the invention allows to select the optimal gripping tool-gripping point pair for safely picking up and handling each product 20 arranged randomly on the service plane 37 depending on the geometric characteristics thereof and, preferably, on other characteristic parameters such as the weight of the product 20, as well as taking into account the working area available to the robotic arm 34 within the robotic inlet station 32a.

The invention thus allows products 20 to be picked up from the service plane 37 and handled within the robotic inlet station 32a in a safe and stable manner and to maintain adequate gripping stability during the handling thereof by the robotic arm 34.

Obviously, in order to meet specific and contingent needs, a person skilled in the art will be able to make numerous modifications and variations to the invention described above, all of which, moreover, are within the scope of protection defined by the following claims.

1. A process for automated handling of products within a plant comprising a workstation which in turn comprises a first robotic arm and a plurality of gripping tools, the process comprising:
arranging said products randomly on a service plane of the workstation;
acquiring an image of the products arranged on the service plane;
processing said image to obtain geometric characteristics of each of the products arranged on the service plane;
for each of said products:
identifying, based on the geometric characteristics which have been respectively obtained, a respective gripping tool among said plurality of gripping tools;
associating the respective identified gripping tool with the first robotic arm;
moving the first robotic arm to grasp the product by the respective gripping tool, moving the grasped product from said service plane to an operating station of the plant and releasing the product in said operating station by the respective gripping tool.

2. The process according to claim 1, wherein identifying the respective gripping tool, among said plurality of gripping tools, for each of the products arranged on the service plane comprises:
accessing, based on the geometric characteristics obtained by processing the image, a database comprising instances of product data relating to a predefined plurality of reference products, wherein the product data comprises geometric characteristics of the reference products and each instance of product data is associated with a gripping tool among said plurality of gripping tools, said gripping tool being associated with a respective score indicative of a probability of having a successful gripping;
retrieving from the database instances of the product data having geometric characteristics corresponding to the geometric characteristics obtained by processing the image, and
identifying said respective gripping tool among the gripping tools which are associated with the instances retrieved from the database based on the scores associated therewith.

3. The process according to claim 1, wherein the geometric characteristics comprise at least one of: shape, size, centre of gravity, volume and spatial arrangement with respect to the service plane.

4. The process according to claim 2, wherein identifying the respective gripping tool comprises identifying an optimal pair formed by the respective gripping tool and a respective gripping mode.

5. The process according to claim 4, wherein:
each instance of the product data in the database is associated with a gripping tool among said plurality of gripping tools, said gripping tool being associated with a plurality of gripping modes, each pair formed by the gripping tool and one of the plurality of gripping modes being associated with a respective score indicative of the probability of having a successful gripping for the pair; and
identification of the optimal pair is performed among the gripping tools and the gripping modes associated therewith in the instances retrieved from the database on the basis based on the score associated with each pair.

6. The process according to claim 4, wherein the gripping mode defines at least one gripping point on the product and operating parameters adapted to drive the gripping tool.

7. The process according to claim 2, comprising obtaining at least one characteristic parameter of the products arranged on the service plane selected from: weight, material, colour and surface characteristics.

8. The process according to claim 7, wherein the product data in the database comprises, in addition to the geometric characteristics, at least one characteristic parameter of the products of the predefined plurality of reference products selected from: weight, material, colour and surface characteristics.

9. The process according to claim 2, wherein if for one of the products arranged on the service plane the database is lacking an instance of product data whose geometric characteristics correspond to the geometric characteristics obtained by processing the image, the identification of the respective gripping tool, among said plurality of gripping tools, is performed by real-time processing the acquired image.

10. The process according to claim 1, wherein before arranging said products randomly on the service plane, said products are contained in a container and wherein arranging said products randomly on the service plane comprises:
picking up said container by an automated transfer device;
tilting or overturning said container above said service plane by moving said automated transfer device.

11. The process according to claim 10, wherein said container is arranged in a transport tray containing a plurality of containers, each container comprising a plurality of identical products.

12. The process according to claim 11, comprising, before picking up said container by said automated transfer device:
transferring said transport tray from an automatic driven vehicle to a first conveyor adjacent to said service plane;
transferring the transport tray from said first conveyor to a detection station adjacent to said first conveyor;
acquiring an image of said transport tray at said detection station.

13. The process according to claim 12, comprising checking a correct positioning of the tray and of the plurality of containers with respect to predetermined reference parameters by processing the acquired image of the transport tray.

14. The process according to claim 1, wherein the gripping tools are selected from the group consisting of: suction cups, callipers, soft callipers, pouring hoppers, hooks and any combination thereof.

15. The process according to claim 1, wherein the service plane is at least in part elastically deformable.

16. The process according to claim 1, wherein the service plane is actuatable.

17. The process according to claim 16, wherein the service plane is actuatable by actuators associated therewith which can be driven independently from each other.

18. The process according to claim 16, wherein the actuators can be driven independently from each other in terms of stroke and actuation frequency.

19. The process according to claim 9, wherein the service plane is actuatable and wherein, before performing said real-time processing of the acquired image, the process comprises sequentially:
actuating the service plane so as to move at least some of the products arranged thereon,
processing the acquired image again to obtain updated geometric characteristics of the products arranged on the service plane,
accessing the database based on the updated geometric characteristics to retrieve the instances of the product data having geometric characteristics corresponding to the updated geometric characteristics and identify said respective gripping tool among the gripping tools which are associated with the instances thus retrieved from the database on the basis of based on the scores associated therewith,
said real-time processing of the acquired image being performed if the database lacks an instance of product data whose geometric characteristics correspond to the updated geometric characteristics.

20. A plant comprising a workstation comprising, in turn, a first robotic arm, a service plane, a plurality of gripping tools arranged near the service plane, an image acquisition device configured to acquire an image of products arranged on the service plane and a computer configured to process said image to obtain geometric characteristics of each of the products arranged on the service plane and, for each of said products, said computer being configured to:
identify, based on the geometric characteristics respectively obtained by processing said image, a respective gripping tool among said plurality of gripping tools;
associate the respective gripping tool with the first robotic arm and
move the first robotic arm to grasp the product by the respective gripping tool, move the grasped product from said service plane to an operating station of the plant and release the product in said operating station by the respective gripping tool.
